(19) United States
(12) Patent Application Publication
(10) Pub. No.: US 2010/0143057 A1
(43) Pub. Date: Jun. 10, 2010

(54) Reciprocating drill unit

(75) Inventor: David Lee Breese, Whitehouse, OH (US)

Correspondence Address: Benjamin A Randall, 448 W. Woodrufff Ave., Toledo, OH, 43604, US

(73) Assignee: Glass City Plastics Incorporated, Holland, OH (US)

(21) Appl. No.: 12/315,578

(22) Filed: Dec. 5, 2008

(51) Int. Cl. B23B 45/00

(52) U.S. Cl. 408/124

(57) ABSTRACT

A reciprocating pneumatically driven drill motor housing for use in repetitive machining operations that uses industry standard motors, chucks and multiple spindle heads. The invention allows the user to limit set up time and obviates the need for fabricating special tooling. The unit is easily mounted on any type of fixture.

### BACKGROUND OF THE INVENTION

The present invention relates to devices for repetitive machining operations. A need exists in industrial manufacturing for a device that can be mounted on a fixture and used on an assembly line or secondary machining line that can perform actions such as drilling, routing and the like. In most of these types of operations the devices used for secondary machining are fabricated by the shop doing the work, are specifically designed for the job and have little if any other use.

### SUMMARY OF THE INVENTION

The present invention provides a device that can easily be mounted on any type of fixture and eliminates the need for fabricating special tooling. The device is designed to use and take advantage of industry standard motors and tooling, limiting down time and obviating the need to design and fabricate special tooling. The invention presented is a pneumatically actuated, reciprocating slide mounted housing which accepts industry standard pneumatic motors, chucks and tooling.

### BRIEF DESCRIPTION OF THE SEVERAL DRAWINGS

FIG. 1 is a perspective view of the invention from the top right side.

FIG. 2 is an exploded view of the invention showing the relationship of it's parts.

FIG. 3 is a perspective view of a collar and drive shaft used for a multiple spindle head.

FIG. 4 is a perspective view showing the underside of the top portion of the invention.

FIG. 5 is a plan view of the invention from the left side.

### DETAILED DESCRIPTION OF THE INVENTION

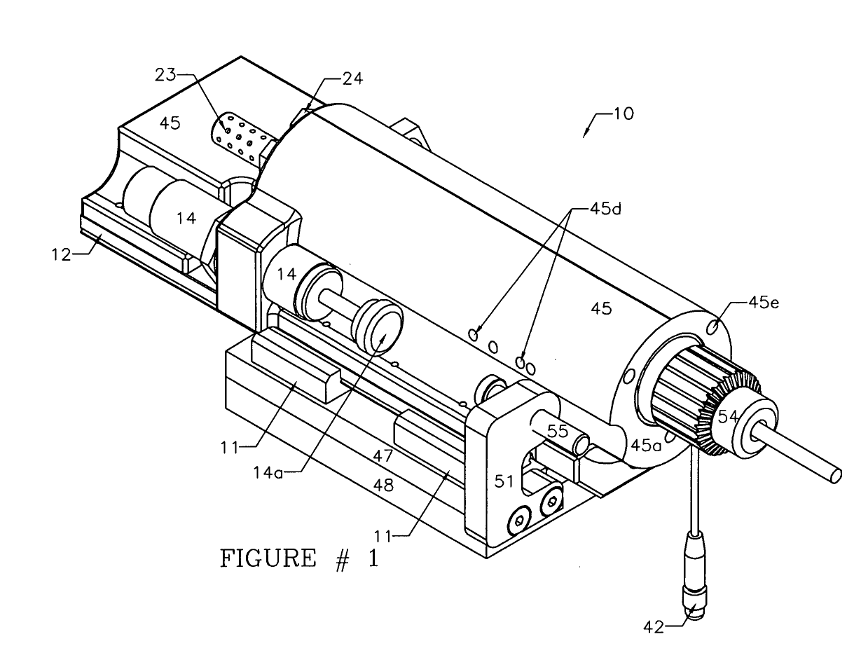

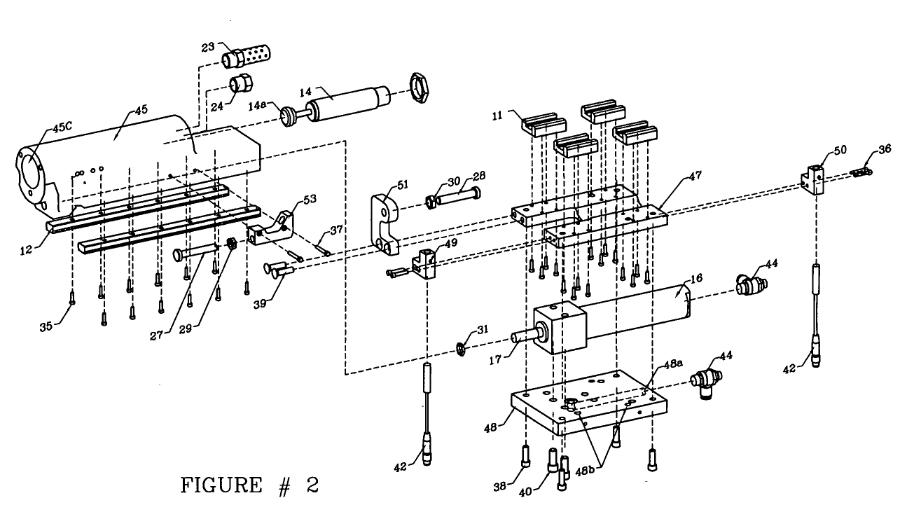

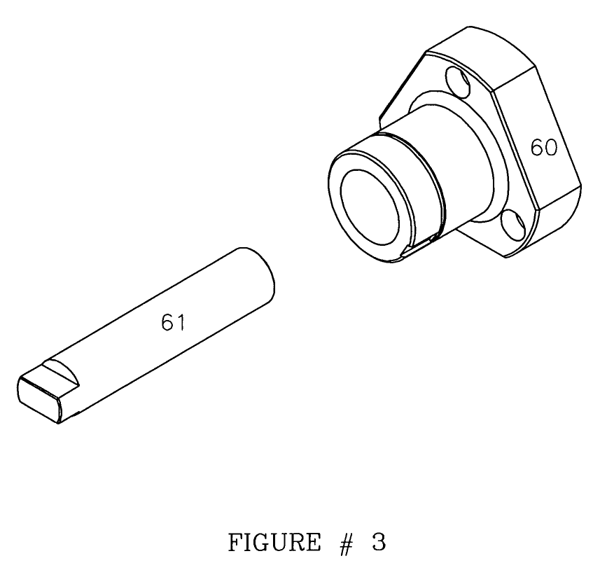

Referring to FIG. 1, the Drill Unit 10, and its main components can be seen. An exploded view is shown in FIG. 2. The Drill Unit 10 comprises a Motor Housing 45, a Bearing Block Mounting Plate 47, a Cylinder Mounting Plate 48, a Pneumatic Cylinder 16 (not shown in FIG. 1), Bearing Blocks 11, Rail Bearings 12, a Velocity Controller 14, a Stop Block 51 and Limit Detectors 42. The Drill Unit 10 is constructed so the Motor Housing 45 is free to move in an axial direction along the Rail Bearings 12 while being constrained from lateral or vertical movement. Axial movement is induced by the Pneumatic Cylinder 16 which is bi-directional and will move the Motor Housing 45 back and forth along the Rail Bearings 12. The motor is not shown in FIG. 1, but a Chuck 54 attached to the motor is shown as it would be in use. Different motors are used for different jobs depending upon the speed, horsepower and torque needed. The motors are industry standard pneumatically driven motors. The motor is held in place using Set Screws 56 which extend through the Motor Housing 45. The Set Screws 56 are provided on both sides of the Motor Housing 45. The front of the Motor Housing 45 has a plurality of mounting holes shown at 45a. These allow the attachment of a Collar 60 shown in FIG. 3. The Collar 60 allows a multiple spindle head to be attached to the Drill Unit 10. The motors used in the Drill Unit 10 have threaded output shafts. The chucks used are threaded onto the motor shaft. When a multiple spindle head is used, it is attached to the Collar 60 using a collet supplied with the spindle head. The collar 60 is supplied with a keyway to prevent the spindle head from slipping. Because of the length of the drive mechanism for a multiple spindle head, an Extension Shaft 61 is supplied with the Drill Unit. The Extension Shaft 61 is threaded on one end to attached to the shaft of the drill motor, and has a square key on the other end that fits into a slot on the input shaft of the multiple spindle head. The Bearing Block Mounting Plate 47 and the Cylinder Mounting Plate 48 are generally rectangular in shape and made from aluminum to decrease weight, although other materials could be used.

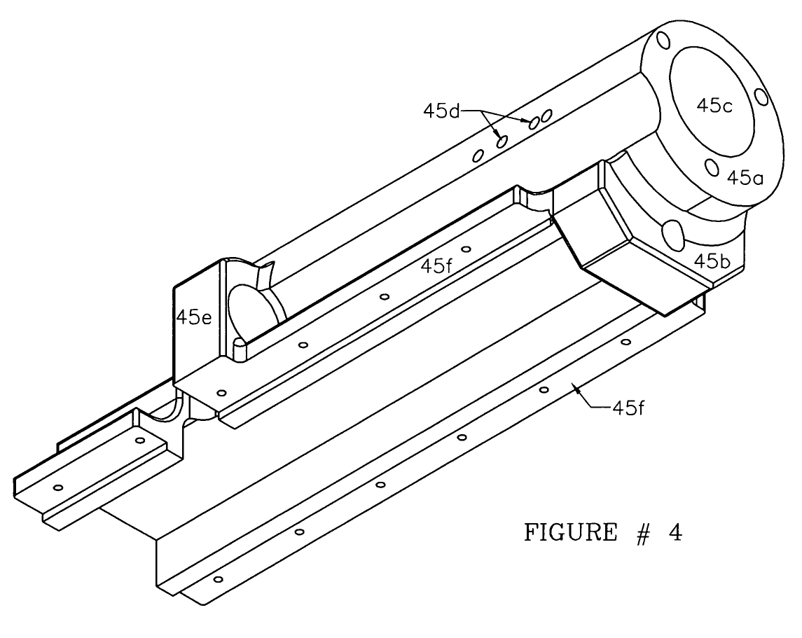

Referring to FIGS. 2 and 4, an exploded view of the invention can be seen and a view from the bottom of the Motor Housing 45. The Motor Housing 45 has an axially elongated Cylindrical Cavity 45c at its upper region that is sized to accept a wide variety of standard motors. The motor is inserted from the Front Face 45a of the Motor Housing 45. Air supply to the motor is provided by a line running through a Sleeve 24 and exhausted through a muffler 23. Again referring to FIGS. 4 and 2, the position and attachment means of the Rail Bearing 12 can be seen. The two parallel Rail Bearings 12 are mounted to the underside of the Motor Housing on two axial, downwardly extending Legs 45f, one on either side of the Motor Housing 45, along it's outer lower edge. The downwardly extending legs define a space to accommodate the Pneumatic Cylinder 16. The Rail Bearings 12 ride in the Bearing Blocks 11, two of which are provided for each Rail Bearing 12. The Bearing Blocks 11 are mounted on the Bearing Block Mounting Plate 47 and spaced apart to provide support and accommodate linear movement of the Motor Housing 45. The Bearing Block Mounting Plate 47 is mounted to the Cylinder Mounting Plate 48. The Bearing Block Mounting Plate 47 is provided with a channel running lengthwise to accommodate the body of the Pneumatic Cylinder 16. The Pneumatic Cylinder 16 is also secured to the Cylinder Mounting Plate 48, on top of the Bearing Block Mounting Plate 47, the body of the Pneumatic Cylinder 16 extending along the channel. The Pneumatic Cylinder 16 has a Threaded Shaft 17 extending from its body. The Threaded Shaft 17 is typical of these types of cylinders. Other means of attachment such as retaining clips can be used and are well known in the art. The use of a cylinder with a threaded shaft is not part of the inventive quality of the present invention, nor is it meant to limit use to cylinders with threaded shafts. The Cylinder 16 is secured to the Motor Housing 45 by means of the Threaded Shaft 17 and a Locking Nut 31, thereby providing the moving force for the Motor Housing 45. The Pneumatic Cylinder 16 is a standard bi-directional pneumatic cylinder. These types of cylinders require two ports for the introduction and release of compressed air, both of which serve alternately as supply or exhaust ports depending on which direction the cylinder is moving. Flow Control Valves 44 at the ports introduce or exhaust air as required. The 44 are industry standard three way valves having an air inlet, an air outlet and an exhaust orifice. Air pressure is supplied to the inlet of the 44 and introduced to the Pneumatic Cylinder without modification. Air is exhausted through the other 44 through the exhaust orifice. The exhaust orifice is sized to limit the speed of travel of the 45 and prevents it from banging back and forth and damaging the unit. To make the Drill Unit 10 more easily used, an Air Channel 48a is provided in the Cylinder Mounting Plate 48 to direct the air flow from the bottom of the Cylinder 16 to the rear of the Reciprocating Mounting Unit 10. This way, all of the air lines run out the back of the unit and do not interfere with mounting or movement of the unit as a whole. When in use, the Reciprocating Mounting Unit 10 will usually be mounted on a fixture using the Mounting Holes 48b provided in the Cylinder Mounting Plate 48.

Referring again to FIG. 1, the mode of movement of the invention will be described. The Motor Housing 45 is free to move axially along the Rail Bearings 12. Forward movement is limited by the Stop Block 51 which comprises an Adjustable Stop Pin 28. The Adjustable Stop Pin 28 will generally be an elongated threaded bolt with a Locking Nut 30 to keep it from moving. During forward movement of the Motor Housing 45, compressed air is applied to the Cylinder 16, moving the Threaded Shaft 17 outward. The Threaded Shaft 17, being secured to the Motor Housing 45, will move the Motor Housing 45 forward within the constraints of the Rail Bearings 12. The Motor Housing 45 will move forward at a rate determined by Cylinder 16 until it is about to engage a work piece. At a distance set by the operator, the Velocity Controller 14 will engage the Adjustable Stop Pin 28. Forward velocity of the Motor Housing 45 will there after be limited by the Velocity Controller 14. The Velocity Controller 14 is a type of shock absorber device well known in the art having an external pin 14a and an internal plunger. When the external Pin 14a impinges upon the Adjustable Stop Pin 28, an air volume inside the Velocity Controller 14 is compressed and allowed to bleed out in a controlled fashion which regulates the forward movement of the Motor Housing 45. The Motor Housing 45 travels forward at a speed determined by the exhaust orifice in the Control Valve 44 until the external pin 14a is engaged. Then the speed is reduced and controlled by the Velocity Controller. The Velocity Controller is adjustable and the speed at which the Motor Housing moves forward after the Velocity Controller is engaged may be set by the operator. The forward travel of the Motor Housing Unit 45 will be terminated by reversing the action of the Cylinder 16 when the desired forward movement is attained.

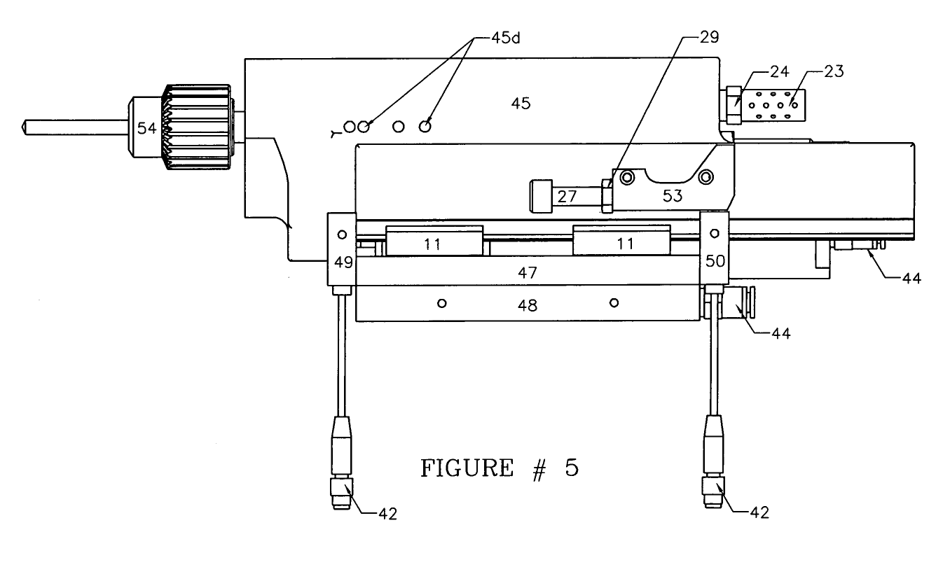

Referring to FIG. 5 the method of determining the position of the Motor Housing 45 will be described. The position of the Motor Housing Unit 45 is determined by a Limit Detector 42 attached to the Front Limit Detector Mounting Block 49. Similarly, rearward movement is detected by a Limit Detector 42 attached to the Rear Limit Detector Mounting Block 50. The limit detectors used in the present invention are proximity detectors of a type well known in the art. They will note the proximity of the forward and rearward edge of an adjustable Limit Actuator 53 which can be seen in the exploded view of FIG. 2. A signal is sent from the Limit Detectors 42 to a controller for the Pneumatic Cylinder 16. The signals are used to actuate the Pneumatic Cylinder 16, causing forward or reverse movement, or ceasing movement altogether. The rearward end of the Limit Actuator 53 is fixed, and the forward end is adjustable. Adjustments in the length of the Limit Actuator 53 are made by using a Threaded Bolt 27 and Locking Nut 29. In keeping with the concept of universality of the invention it should be noted that the ancillary components are easily obtainable and will not require the end user to either fabricate or purchase special parts in order to make modifications or repairs to the unit.

Referring to FIG. 4, a bottom view of the Motor Housing 45 is presented. In this view, the downwardly extending Legs 45f which the Rail Bearing 12 are secured to, can be seen. It can also be seen how the legs provide clearance for the body of the Cylinder 16. In the preferred embodiment, the Motor Housing 45 is a single piece, either machined or cast from aluminum. The upper portion of the Motor Housing 45 includes an axially extending Cylindrical Cavity 45c for holding and securing a motor. A motor is inserted into the Motor Housing 45 through an opening in the front face 45a and secured into the cylindrical cavity, 45c. The motor is secured in the cavity 45c and held in place using a plurality of set screws using threaded holes 45d. At the front of the Motor Housing 45 on it's lower edge an elongated buss 45b is provided to secure the Threaded Shaft 17 of the Cylinder 16. A second elongated buss 45e is provided on the side of the Motor Housing 45 to secure the Velocity Controller 15.

The invention having been completely described, what is claimed is:

1. A device for performing repetitive machining operations comprising:
a planar rectangular mounting base having a plurality of holes for securing said base to a fixture,
a rectangular bearing support plate secured to an upper face of said mounting base,
a pneumatic cylinder having an extensible shaft, said cylinder centrally mounted on said upper surface of said mounting base, parallel to a long axis of the mounting base,
an upper section having a forwardly located axially elongated cavity for holding a drill motor,
said upper section slideably mounted on said bearing support plate so that it may move axially along said long axis and affixed to the extensible shaft of said pneumatic cylinder,
means for supplying and controlling an air supply to said pneumatic cylinder to extend and withdraw said extensible shaft thereby providing reciprocal motion to said upper section.

2. The device of claim 1 wherein said cylinder is secured to said mounting base on said upper face, the bearing support plate being mounted between the cylinder and the mounting base and wherein said bearing support plate has a depression providing clearance for the cylinder.

3. The device of claim 1 wherein the upper section is machined from an aluminum block and comprises an upper section having an elongated cylindrical cavity, a central rectangular planar section having a top section contiguous with said upper section, a forward end, a rearward end, a lower side, and two opposite parallel edges, said opposite parallel edges comprising two legs downwardly extending from said lower side, said legs defining a cavity between them and a lower surface of said upper section.

3. The device of claim 3 wherein said upper section is cast rather than machined.

4. The device of claim 3 wherein said legs have a lower face with a rail bearing attached thereto, and further wherein said bearing support plate has a plurality of bearing blocks secured to an upper surface for supporting said rail bearings.

5. The device of claim 3 wherein said pneumatic cylinder is located in said cavity between said legs and said extensible shaft is secured to a boss extending in a downward direction from the forward end of said upper portion.

6. The device of claim 3 wherein said mounting base is provided with an interior channel for the introduction and exhaust of an air supply for the pneumatic cylinder wherein said channel runs to the read of the mounting base.

7. The device of claim 3 wherein said upper section includes a velocity controller attached to an outside edge of said upper section, said velocity controller comprising an adjustable stop mounted on a forward edge of said bearing support plate.

8. The device of claim 3 wherein said forward end of said upper section includes a plurality of mounting holes for securing a collar, said collar comprising a rear mounting base having a plurality of holes coincident with said holes in the forward end of said upper section, and a hollow cylindrical extension perpendicular to said base and extending outward from said front end of said upper section, said extension provided with a keyway and sized to accept a mounting collet of a multiple spindle drill head.

9. The Device of claim 8 wherein an elongated cylindrical extension shaft is provided having a first end with an internal thread sized to mate with an output shaft of said drill motor and a second end having a rectangular key to mate with an input shaft of said multiple spindle head to transmit motive force from said drill motor to said multiple spindle head.
